(19) United States
(12) Patent Application Publication
(10) Pub. No.: US 2026/0220843 A1
(43) Pub. Date: Jul. 30, 2026

(54) IMAGE EDITING BASED ON INSTRUCTION

(71) Applicant: Lemon Inc., Grand Cayman (KY)

(72) Inventors: Ming Li, Los Angeles, CA (US); Sijie Zhu, Los Angeles, CA (US); Fan Chen, Los Angeles, CA (US); Longyin Wen, Los Angeles, CA (US)

(21) Appl. No.: 19/038,037

(22) Filed: Jan. 27, 2025

(51) Int. Cl. G06T 11/60; G06F 40/40; G06V 10/774

(52) U.S. Cl. CPC G06T 11/60; G06F 40/40; G06V 10/774

(57) ABSTRACT

Example embodiments of the present disclosure relate to a method, an electronic device, a computer readable storage medium, and a computer program product for image editing based on an editing instruction using an editing model. In the solution, a model input comprising an original image and an editing instruction may be input into a trained editing model to obtain a model output which comprises an edited image corresponding to the model input. The trained editing model is determined based on a training dataset comprising a plurality of positive and negative sample pairs, where a positive sample in a positive and negative sample pair comprises original sample data, a right instruction, and edited sample data, and a negative sample in the positive and negative sample pair comprises the original sample data, a wrong instruction, and the edited sample data.

### FIELD

Various example embodiments relate to the field of computing science and in particular, to a method, an electronic device, a computer readable storage medium, and a computer program product for image editing based on an editing instruction using an editing model.

### BACKGROUND

In recent years, significant progress has been made in text-to-image (T2I) generation due to the development of diffusion models. These T2I diffusion models can generate images that align with natural language descriptions while satisfying human perception and preferences. Consequently, numerous image editing methods based on these models have been proposed to achieve various editing effects. Instruction-based methods have become increasingly popular as they allow users to conveniently and easily modify images using language instructions, without the need to provide masks, as required by mask-based methods.

Collecting perfect data for instruction-based image editing tasks is challenging, leading to inaccurate supervision signals and poor performance. Existing methods attempt to improve editing models through generating higher-quality edited images, pre-training on recognition tasks or introducing additional vision-language models but fail to resolve the fundamental issue of noisy supervision. In this event, how to obtain an effective model for image editing should be addressed.

### SUMMARY

In general, example embodiments of the present disclosure provide a solution for instruction-based image editing using an editing model.

In a first aspect, there is provided a method. The method comprises: obtaining a model input comprising an original image and an editing instruction; and determining a model output by inputting the model input into a trained editing model, wherein the model output comprises an edited image corresponding to the model input, wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In a second aspect, there is provided an electronic device. The electronic device comprises: at least one processor; and at least one memory storing instructions, wherein the instructions when executed by the at least one processor, cause the electronic device at least to: obtain a model input comprising an original image and an editing instruction; and determine a model output by inputting the model input into a trained editing model, wherein the model output comprises an edited image corresponding to the model input, wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In a third aspect, there is provided a non-transitory computer readable medium comprising program instructions for causing an apparatus to: obtain a model input comprising an original image and an editing instruction; and determine a model output by inputting the model input into a trained editing model, wherein the model output comprises an edited image corresponding to the model input, wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In a fourth aspect, there is provided a computer program comprising instructions, which, when executed by an apparatus, cause the apparatus to perform at least the method in the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example schematic for generating an edited image by using a large language model (LLM);

FIG. 2 illustrates an example schematic of an environment in which some example embodiments of the present disclosure may be implemented;

FIG. 3 illustrates a flowchart of a method for determining a dataset in accordance with some example embodiments of the present disclosure;

FIG. 4A illustrates an example for guiding the VLM based on the generation attributes in accordance with some example embodiments of the present disclosure;

FIG. 4B illustrates an example for determining at least one wrong instruction in accordance with some example embodiments of the present disclosure;

FIG. 5 illustrates a flowchart of a method for training the editing model in accordance with some example embodiments of the present disclosure;

FIG. 6 illustrates an example for training the editing model in accordance with some example embodiments of the present disclosure;

FIG. 7 illustrates a flowchart of a method for using the editing model in accordance with some example embodiments of the present disclosure;

FIG. 8 illustrates an example for determining a model output in accordance with some example embodiments of the present disclosure; and

FIG. 9 illustrates a schematic block diagram of an example device that can be used to implement embodiments of the present disclosure.

Throughout the drawings, the same or similar reference numerals represent the same or similar elements, unless otherwise indicated.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

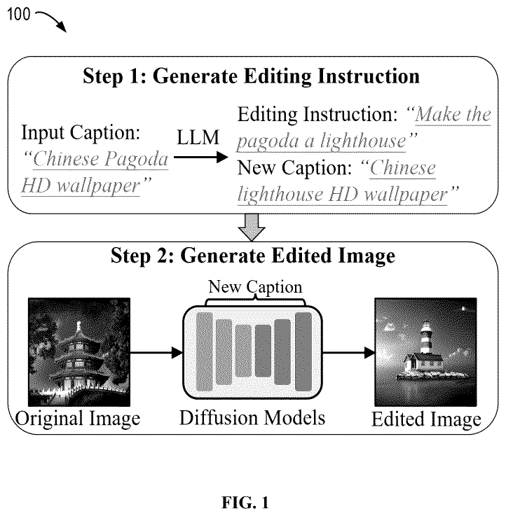

The training of instruction-based editing models requires the original image, edited image, and corresponding editing text, making it difficult to manually create or collect a large amount of relevant data. To address the issue of scarce training data, existing efforts have attempted to develop various automated pipelines to synthesize large datasets. Specifically, most methods first use large language models (LLMs) to modify the text descriptions of original images. The original images and modified texts are then input into various pre-trained diffusion models to automatically generate edited images. FIG. 1 illustrates an example schematic for generating 100 an edited image by using LLM. However, having LLMs generate corresponding editing instructions based solely on the captions of the original images can introduce content that is completely unrelated to the images, resulting in very strange edited images. Additionally, current text-to-image diffusion models cannot generate images that fully correspond to the input text prompts, inevitably changing parts of the original images that do not require editing, leading to mismatched editing instructions and original-edited image pairs, thus resulting in noisy supervision signals.

Embodiments of the present disclosure provides a solution for instruction-based image editing using an editing model. In the solution, a training dataset includes sample data, and the sample data includes an original image sample, an edited image sample, a rectified instruction, and a wrong instruction. In addition, the editing model can be trained based on the training dataset. Since the wrong instruction is used for training, the rectified instruction's predicted noise is made to be closer to the sampled training diffusion noise. Therefore, the trained editing model can be more effective. Principles and implementations of the present disclosure will be described in detail below with reference to the figures.

In the present disclosure, the term “editing model” may be used interchangeably with any of the following: an image-editing model, a de-noising model, a diffusion model, an instruction-based image editing model, an instruction-based diffusion model, an instruction-based editing model, a model, an image-editing encoder, an encoder, etc. the present disclosure does not limit the name of the model/encoder.

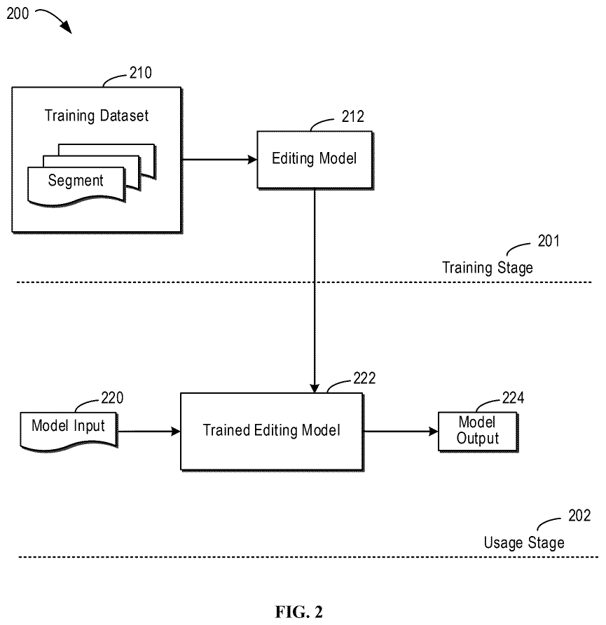

FIG. 2 illustrates an example schematic of an environment 200 in which some example embodiments of the present disclosure may be implemented. As illustrated, the environment 200 includes a training stage 201 and a usage stage 202.

The training stage 201 may be a training process during which the editing model 212 is trained or updated based on a training dataset 210. A trained editing model 222 can be generated or determined after the training stage 201. The training stage 201 may also be referred to as a pre-training stage for the editing model 212 and the present disclosure does not limit for this aspect.

The usage stage 202 may use the trained editing model 222, e.g., to determine a model output 224 based on a model input 220. The usage stage 202 may also be referred to as an inference stage for the trained editing model 222 and the present disclosure does not limit for this aspect.

It should be noted that the training stage 201 and the usage stage 202 may be executed on a same device or different devices. For instance, the training stage 201 may be executed on a first device while the usage stage 202 may be executed on a second device. For instance, the training stage 201 may be executed on a server while the usage stage 202 may be executed on a user device.

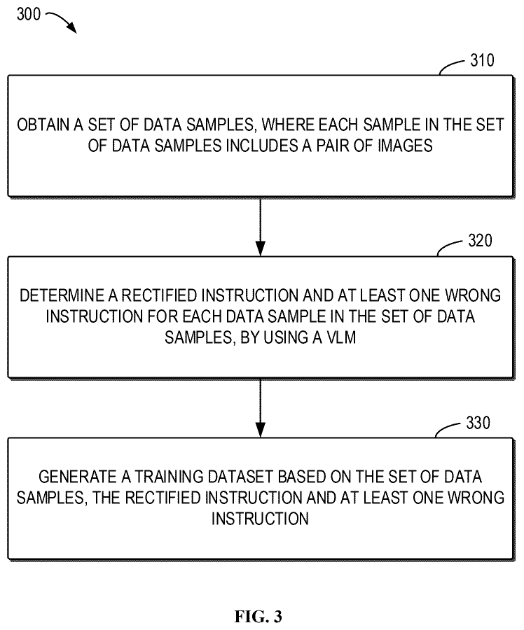

FIG. 3 illustrates a flowchart of a method 300 for determining a training dataset 210 in accordance with some example embodiments of the present disclosure. For ease of description, it is assumed that the method 300 is performed by an electronic device.

At 310, a set of data samples are obtained, where each sample in the set of data samples includes a pair of images. A320, a rectified instruction and at least one wrong instruction is determined for each data sample in the set of data samples, by using a vision-language model (VLM). At 330, a training dataset is generated based on the set of data samples, the rectified instruction and at least one wrong instruction.

In the present disclosure, the term “rectified instruction” may also be referred to as a rectified editing instruction or a right instruction or a positive instruction, and the term “wrong instruction” may also be referred to as an image-related wrong instruction or a negative instruction. In the present disclosure, the term “training dataset” may also be referred to as a dataset, a set of data for training an editing model, or the like.

In some implementations, the set of data samples may be obtained from an existing dataset source, which may include a plurality of data samples. Each data sample in the set may be represented as [original sample data, edited sample data], where “original sample data” and “edited sample data” form a pair of images. For example, a pair of images may be referred to as an original-edited image pair. For example, the original sample data may be an original image in the pair and the edited sample data may be an edited image in the pair. In some examples, one data sample in the set may further include an initial instruction.

In some implementations, there may be multiple candidate vision-language models, and one of them may be selected as the VLM that being used at 320. In some examples, the VLM used at 320 may also be referred to as a multimodal large model, and the present disclosure does not limit for this aspect. In some examples, the VLM may be selected from the multiple candidate vision-language models based on effectiveness of the multiple candidate vision-language models capable of multi-image understanding. For example, the capability of multiple candidate vision-language models may be analyzed to understand the original-edited image pairs in the set of data samples.

In some examples, the selected VLM is used for editing instruction rectification on the set of data samples. In some examples, generation priors from text-to-image diffusion may be used to guide the VLM to rectify editing instructions.

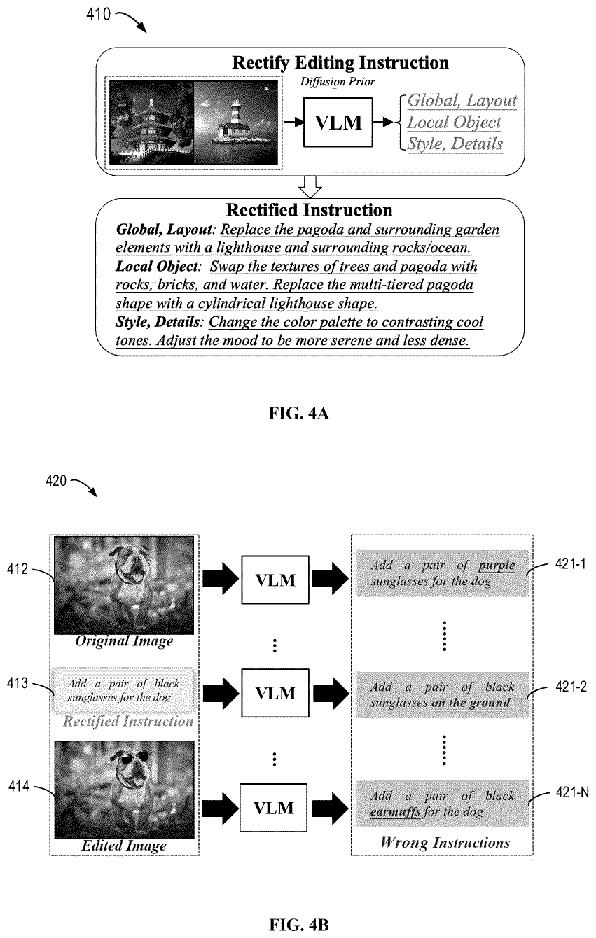

In some embodiments, different time-steps play distinct roles in image generation for text-to-image diffusion models, regardless of the text prompt. Specifically, diffusion models focus on background and layout in the early stages, object attributes in the mid stages, and image details in the late stages of sampling. For example, the set of data samples may be generated by: generating image layout and background in the early stages, generating local object attributes in the mid stages, and focusing on image details in the later stages, with style changes throughout all stages. In some examples, the VLM used at 320 may be guided based on these generation attributes, to establish a unified rectification method for various editing instructions. FIG. 4A illustrates an example 410 for guiding the VLM based on consider these generation attributes. As such, a unified and general guideline may be defined for the VLM to rectify and facilitate the instructions. Since a rectified instruction is determined, an issue of noisy supervision arising from a misalignment between an initial instruction and the original-edited image pair can be addressed.

For example, the VLM may be guided to generate rectified instructions according to the generation attributes defined by diffusion priors. For example, for a specific original-edited image pair, a rectified instruction can be determined. As illustrated in FIG. 4B, an original-edited image pair includes original sample data 412 and edited sample data 414, the rectified instruction 413 may be determined. In some examples, the initial instruction may be used as a reference for determining the rectified instruction, and the rectified instruction is more accurate than the initial instruction if any.

In some embodiments, the initial instruction may be accurate enough for characterizing the difference between the original sample data and the edited sample data, in this case, the initial instruction may be taken as the rectified instruction directly.

In addition, at least one wrong instruction may be further determined (or generated) based on the rectified instruction and the original-edited image pair, e.g., by using the VLM. That is, at least one wrong instruction may be generated for each original-edited image pair. In some examples, the original-edited image pair and the rectified instruction may be taken as input of VLM, and the output of VLM may be the at least one wrong instruction. In some examples, the at least one wrong instruction may be generated by random replacement of one or more phrases within the rectified instruction, for example, random replacements of quantities, spatial locations, and/or objects within the rectified instruction may be performed.

The VLM is used to modify attributes in the rectified instruction, such as quantity, spatial relationships, or object types, to create different wrong instructions. For example, the VLM is configured to modify only a single attribute from the rectified instruction in each wrong instruction, keeping most of the editing text unchanged. FIG. 4B illustrates an example 420 for determining at least one wrong instruction in accordance with some example embodiments of the present disclosure. As illustrated in FIG. 4B, multiple wrong instructions 421-1 to 421-N may be generated for the original-edited image pair 412 and 414, where the underlined phrases are those modified by the VLM to generate wrong instructions.

In addition, a training dataset may be generated at 330. In some embodiments, the training dataset may include a plurality of samples, one sample may be represented as [original sample data, edited sample data, rectified instruction, at least one wrong instruction]. In some examples, the sample may be regarded as a positive and negative sample pair, e.g., a pair of a positive sample [original sample data, edited sample data, rectified instruction] and a negative sample [original sample data, edited sample data, at least one wrong instruction].

It should be noted that the representation of a sample/dataset in the present disclosure is only for illustration without any limitation, some other form of representation may be used and the present disclosure does not limit for this aspect. For example, in the following description, the training dataset includes a plurality of positive and negative sample pairs. A positive sample in a positive and negative sample pair comprises original sample data, a right instruction (i.e., the rectified instruction mentioned above), and edited sample data; and a negative sample in the positive and negative sample pair comprises the original sample data, a wrong instruction, and the edited sample data. For example, a wrong instruction may be randomly selected from the at least one wrong instruction determined above. For example, the right and wrong instructions may be a better-aligned instructions for the original-edited sample data pair.

According to embodiments with reference to FIGS. 3-4B, a training dataset may be generated for training an editing model. A VLM that understands a difference between original sample data and edited sample data is used for determining a right (i.e. rectified) instruction. As such, a more effective instruction can be constructed to better align with the original-edited image pair, to enhance supervision signals. In addition, at least one wrong instruction is determined for constructing negative samples.

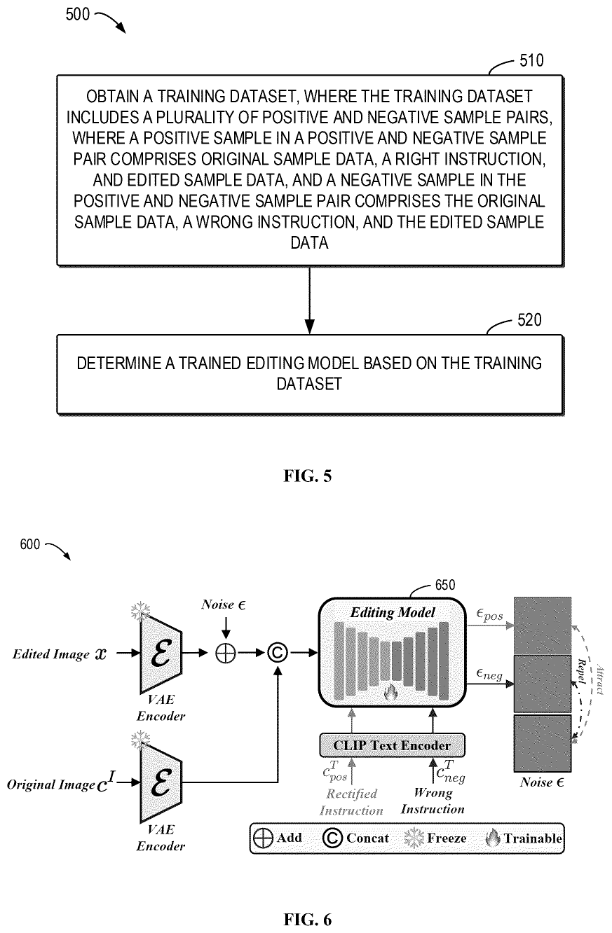

FIG. 5 illustrates a flowchart of a method 500 for training the editing model in accordance with some example embodiments of the present disclosure. The method 500 may be performed by an electronic device which may be the same as or different from that which performs the method 300.

At 510, a training dataset is obtained, where the training dataset includes a plurality of positive and negative sample pairs, where a positive sample in a positive and negative sample pair comprises original sample data, a right instruction, and edited sample data, and a negative sample in the positive and negative sample pair comprises the original sample data, a wrong instruction, and the edited sample data. At 520, a trained editing model is determined based on the training dataset. In addition or alternatively, the trained editing model may be stored or be provided to another apparatus for further use.

In some examples, the training dataset obtained at 510 may be that generated at 330 in FIG. 3, details of which will not be repeated for brevity.

In some implementations, the trained editing model may be determined based on a positive and negative sample pair in the training dataset. In some examples, a positive sample and a negative sample in one positive and negative sample pair may include an image pair and contrastive instructions.

In some examples, a variational autoencoder (VAE) and a text encoder may be used during the training of the editing model. For example, the VAE and the text encoder are frozen (unchanged, not updated) while training the editing model.

In some implementations, the trained editing model may be determined based on a training loss which includes a first loss and a second loss. In some examples, a first loss is determined based on a positive noise that is associated with a positive sample. In some examples, a second loss is also referred to as a triplet loss, which is determined based on a positive noise and a negative noise. For example, the triplet loss may be used for contrastive supervision. For example, the second loss is determined based on a first distance between the positive noise and a true noise, and a second distance between the negative noise and the true noise.

For ease of description, original sample data in a positive and negative sample pair may be represented as c^{I}, edited sample data in the positive and negative sample pair may be represented as x, a right instruction in the positive and negative sample pair may be represented as

$${c}_{pos}^{T} ,$$

and a wrong instruction in the positive and negative sample pair may be represented as

$${c}_{neg}^{T} .$$

During training, a sampled timestep t∈T may be added to obtain a corresponding noised edited image xₜ which satisfied the following formula:

$${x}_{t} = \sqrt{{\overline{α}}_{t}} x + \sqrt{1 - {\overline{α}}_{t}} ϵ \qquad ( 1 )$$

where ∈ is a noise map sampled from a Gaussian distribution ∈~ [symbol] (0, I); and

$${\overline{α}}_{t} := {\prod }_{s = 0}^{t} {α}_{s} , {α}_{t} = 1 - {β}_{t}$$

is a differentiable function of timestep t.

Both

$${c}_{pos}^{T} and {c}_{neg}^{T}$$

are fed into the model to predict noises including a positive noise (represented as ∈ₚₒₛ) and a negative noise (represented as ∈_{neg}), which may be represented by the formulas:

$${ϵ}_{pos} = {ϵ}_{θ} ( concat ( {x}_{t} , {c}^{I} ) , t , {c}_{pos}^{T} ) \qquad ( 2 )$$

$${ϵ}_{neg} = {ϵ}_{θ} ( concat ( {x}_{t} , {c}^{I} ) , t , {c}_{neg}^{T} ) \qquad ( 3 )$$

where concat (xₜ, c^{I}) refers to concatenating the VAE image latents of the noised edited image xₜ and the original sample data c^{I}.

For training the model, an aim is to make the noise ∈ₚₒₛ (predicted by the positive sample) to be closer to the true noise Et sampled during training, compared to the noise ∈_{neg} (predicted by the negative sample).

In some examples, a first loss and a second loss may be defined by:

$${ℒ}_{train} = d ( {ϵ}_{t} , {ϵ}_{pos} ) \qquad ( 4 )$$

$${ℒ}_{triplet} = max \{ d ( {ϵ}_{t} , {ϵ}_{pos} ) - d ( {ϵ}_{t} , {ϵ}_{neg} ) + m , 0 \} \qquad ( 5 )$$

where [symbol] ₜᵣₐᵢₙ is first loss and [symbol] ₜᵣᵢₚₗₑₜ is the second loss

$$d ( x 1 , x 2 ) = {‖ x 1 - x 2 ‖}_{2}^{2}$$

and margin m is a hyper-parameter.

As such, a goal that to make the rectified instruction's predicted noise closer to the sampled training diffusion noise, which pushing the wrong instruction's noise further away can be achieved.

In addition, a training loss may be determined based on the first loss and the second loss, for example, based on the following formula:

$${ℒ}_{total} = {ℒ}_{train} + λ \cdot {ℒ}_{triplet} \qquad ( 6 )$$

FIG. 6 illustrates an example 600 for training the editing model in accordance with some example embodiments of the present disclosure. As illustrated, original sample data (original image as shown in FIG. 6) c^{I} is input into a VAE encoder, and a latent representation of the c^{I}. Edited sample data (edited image as shown in FIG. 6) x is input into a VAE encoder, and a latent representation of the x. In addition, a noise e is added to the latent representation of the x, a result of which will be concatenated with the latent representation of the c^{I}. Then the concatenated result will be input into the model 650. As illustrated, both the rectified (i.e. right) instruction and the wrong instruction will be input into the model 650 via a text encoder such as a contrastive language-image pretraining (CLIP) text encoder as shown in FIG. 6. In addition, the noise ∈ₚₒₛ and the noise ∈_{neg} can be determined, and accordingly the model 650 can be trained based on the noises ∈ₚₒₛ, ∈_{neg} and ∈.

As mentioned above, the wrong instruction may be generated by replacing one or several words of a rectified instruction. It is understood that since only a few words are replaced between the rectified instruction and the wrong instruction, the text embeddings produced by the CLIP text encoder that serve as input to the model will also be similar. This ensures the task's learning difficulty, helping the model understand how subtle differences between the two editing instructions result in significantly different editing results.

It should be noted that the VAE encoder used for determining a latent representation of an image may be used during the training of the editing model. For example, the VAE encoder may be unchanged, the parameters of the VAE encoder are not updated, while the parameters of the editing model are updated.

According to embodiments with reference to FIGS. 5-6, the editing model may be generated or determined based on contrastive instructions. Accordingly, the editing model can learn from both positive and negative instructions, further facilitating supervision signal effectiveness. There is no need to introduce additional model architectures or pre-training tasks, achieving superior performance with a small amount of training data.

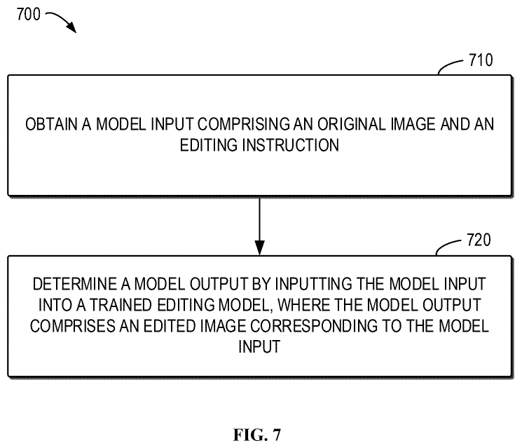

FIG. 7 illustrates a flowchart of a method 700 for using the editing model in accordance with some example embodiments of the present disclosure. The method 700 may be performed by an electronic device which may be the same as or different from that which performs the method 500.

At 710, a model input comprising an original image and an editing instruction is obtained. At 720, a model output is determined by inputting the model input into a trained editing model, where the model output comprises an edited image corresponding to the model input.

In some implementations, the trained editing model may be obtained. For example, the trained editing model is stored in the storage of the electronic device or in a cloud/server. For example, the editing model may be trained and determined by the electronic device or by another device or server.

In some examples, a VAE encoder may also be used. For example, the original image may be input into the VAE encoder to determine a latent representation of the original image. In addition, the editing instruction and the latent representation may be input into the trained editing model to obtain the model output. For example, the model output is an edited image corresponding to the original image and the editing instruction.

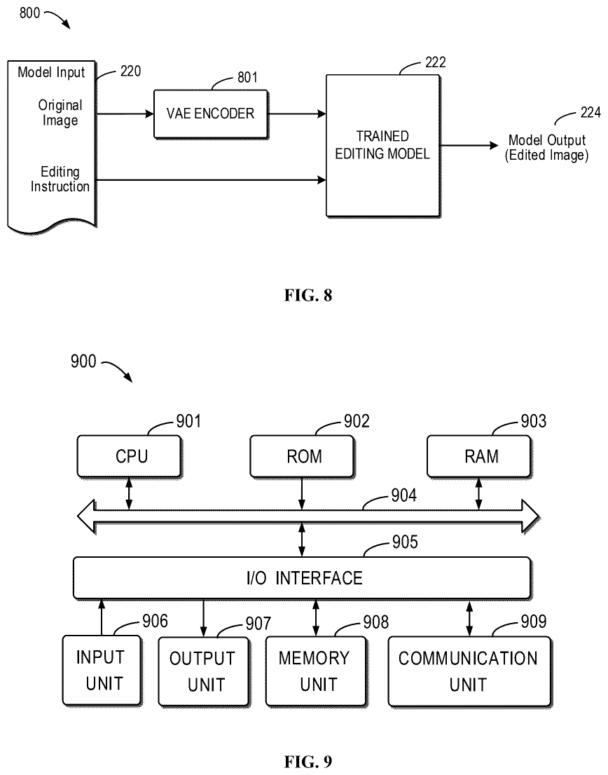

FIG. 8 illustrates an example 800 for determining a model output in accordance with some example embodiments of the present disclosure. As illustrated, the model input 220 includes an original image and an editing instruction, where the original image may be input into the VAE encoder 801. In addition, the output of the VAE encoder 801 and the editing instruction may be input into the trained editing model 222 to obtain a model output 224, which may be an edited image.

According some embodiments in the present disclosure, a rectified instruction may be determined for an original-edited image pair, and the alignment of the rectified instruction and the original-edited image pair can improve the performance of the editing model. In addition, both right and wrong (positive and negative) instructions are considered for training, thus the editing model can learn from both positive and negative instructions, thereby facilitating supervision signal effectiveness.

Therefore, the present disclosure provides a direct and efficient way to provide better supervision signals, providing a simple and effective solution for instruction-based image editing. According to the editing model determined in the present disclosure, a 12.26% improvement can be achieved while reducing 30 times data and 13 times model parameters, comparing with an existing method such as SmartEdit.

In some example embodiments, an apparatus capable of performing any method (for example, an electronic device) may comprise means for performing the respective steps of the method. The means may be implemented in any suitable form, such as units, modules, elements, or processors configured to perform the corresponding recited functionality or functionalities. For example, the means may be implemented in a circuitry or software module.

FIG. 9 illustrates a simplified block diagram of a device 900 that is suitable for implementing some example embodiments of the present disclosure. As illustrated therein, the device 900 includes a central processing unit (CPU) 901 that may perform various appropriate actions and processing based on computer program instructions stored in a Read-Only Memory (ROM) 902 or loaded from a memory unit 908 to a Random-Access Memory (RAM) 903. In the RAM 903, there may further store various programs and data needed for operations of the device 900. The CPU 901, ROM 902 and RAM 903 are connected to each other via a bus 904. An input/output (I/O) interface 905 is also connected to the bus 904.

Various components in the device 900 are connected to the I/O interface 905, including: an input unit 906 such as a keyboard, a mouse and the like; an output unit 907 such as various types of displays and loudspeakers, etc.; a memory unit 908 such as a magnetic disk, an optical disk, and etc.; and a communication unit 909 such as a network card, a modem, and a wireless communication transceiver, etc. The communication unit 909 allows the device 900 to exchange information/data with other devices via a computer network such as the Internet and/or various types of telecommunications networks. It is understood that the present disclosure may display, via the output unit 907, real-time dynamic change information of the customer satisfaction, key factor identification information of a group of customers or individual customers subjected to the satisfaction, optimized strategy information, and strategy implementation effect assessment information, etc.

The processing unit 901 may be implemented by one or more processing circuits. The processing unit 901 may be configured to perform various processes and processing described above. For example, in some embodiments, the process described above may be implemented as a computer software program that is tangibly embodied on a machine readable medium, e.g., the memory unit 908. In some embodiments, part or all of the computer program may be loaded and/or mounted onto the device 900 via ROM 902 and/or communication unit 909. When the computer program is loaded to the RAM 903 and executed by the CPU 901, one or more steps of the process as described above may be executed.

It is to be understood that although FIG. 9 is shown as an illustrative device to perform the process or method shown above, the embodiments of the present disclosure may also be implemented at one or more quantum computers, the present disclosure does not limit this aspect.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one aspect, there is provided a method, such as a computer-implemented method. The method comprises: obtaining a model input comprising an original image and an editing instruction; and determining a model output by inputting the model input into a trained editing model, wherein the model output comprises an edited image corresponding to the model input, wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In some implementations, the method further comprises: obtaining the trained editing model which is determined by the following: determining a positive noise and a negative noise based on the positive and negative sample pair; determining a training loss based on the positive noise and the negative noise; and determining the trained editing model based on the training loss.

In some implementations, the training loss comprises: a first loss associated with the positive noise, and a second loss for contrastive supervision.

In some implementations, the second loss is determined based on: a first distance between the positive noise and a true noise, and a second distance between the negative noise and the true noise.

In some implementations, the right instruction is determined for a pair of the original sample data and the edited sample data by using a vision-language model.

In some implementations, the vision-language model is selected from a plurality of candidate vision-language models based on model capability for image understanding.

In some implementations, for a generation from the original sample data to the edited sample data, image layout and background are generated in an early stage, local object attributes are focused in a mid stage, and image details are focused in a later stage, with style changes throughout each of the early, mid, and later stages.

In some implementations, the wrong instruction is determined by a replacement of at least one phrase within the right instruction: quantities, spatial locations, or objects.

In some implementations, the method further comprises: inputting the original image into a variational autoencoder to determine a latent representation of the original image; and inputting the editing instruction and the latent representation into the trained editing model to obtain the model output.

In another aspect, there is provided an electronic device. The electronic device comprises: at least one display; at least one memory; and at least one processor coupled with the at least one memory and configured to cause the device to: obtain a model input comprising an original image and an editing instruction; and determine a model output by inputting the model input into a trained editing model, wherein the model output comprises an edited image corresponding to the model input, where the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In some implementations, the electronic device is further caused to: obtain the trained editing model which is determined by the following: determining a positive noise and a negative noise based on the positive and negative sample pair; determining a training loss based on the positive noise and the negative noise; and determining the trained editing model based on the training loss.

In some implementations, the electronic device is further caused to: input the original image into a variational autoencoder to determine a latent representation of the original image; and input the editing instruction and the latent representation into the trained editing model to obtain the model output.

In a further aspect, there is provided a non-transient computer readable medium having instructions stored thereon, the instructions, when executed by a processor of a device, causing the device to: obtain a model input comprising an original image and an editing instruction; and determine a model output by inputting the model input into a trained editing model, wherein the model output comprises an edited image corresponding to the model input, wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

In some implementations, the program instructions are causing the apparatus to: obtain the trained editing model which is determined by the following: determining a positive noise and a negative noise based on the positive and negative sample pair; determining a training loss based on the positive noise and the negative noise; and determining the trained editing model based on the training loss.

In some implementations, the program instructions are causing the apparatus to: input the original image into a variational autoencoder to determine a latent representation of the original image; and input the editing instruction and the latent representation into the trained editing model to obtain the model output.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A method comprising:
obtaining a model input comprising an original image and an editing instruction; and
determining a model output by inputting the model input into a trained editing model, wherein the model output comprises an edited image corresponding to the model input,
wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

2. The method of claim 1, further comprising:
obtaining the trained editing model which is determined by the following:
determining a positive noise and a negative noise based on the positive and negative sample pair;
determining a training loss based on the positive noise and the negative noise; and
determining the trained editing model based on the training loss.

3. The method of claim 2, wherein the training loss comprises:
a first loss associated with the positive noise, and
a second loss for contrastive supervision.

4. The method of claim 3, wherein the second loss is determined based on:
a first distance between the positive noise and a true noise, and
a second distance between the negative noise and the true noise.

5. The method of claim 1, wherein the right instruction is determined for a pair of the original sample data and the edited sample data by using a vision-language model.

6. The method of claim 5, wherein the vision-language model is selected from a plurality of candidate vision-language models based on model capability for image understanding.

7. The method of claim 1, wherein for a generation from the original sample data to the edited sample data, image layout and background are generated in an early stage, local object attributes are focused in a mid stage, and image details are focused in a later stage, with style changes throughout each of the early, mid, and later stages.

8. The method of claim 1, wherein the wrong instruction is determined by a replacement of at least one phrase within the right instruction: quantities, spatial locations, or objects.

9. The method of claim 1, further comprising:
inputting the original image into a variational autoencoder to determine a latent representation of the original image; and
inputting the editing instruction and the latent representation into the trained editing model to obtain the model output.

10. An electronic device comprising:
at least one processor; and
at least one memory storing instructions that, when executed by the at least one processor, cause the electronic device at least to:
obtain a model input comprising an original image and an editing instruction; and
determine a model output by inputting the model input into a trained editing model, wherein the model output comprises an edited image corresponding to the model input,
wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

11. The electronic device of claim 10, wherein the electronic device is further caused to:
obtain the trained editing model which is determined by the following:
determining a positive noise and a negative noise based on the positive and negative sample pair;
determining a training loss based on the positive noise and the negative noise; and
determining the trained editing model based on the training loss.

12. The electronic device of claim 11, wherein the training loss comprises:
a first loss associated with the positive noise, and
a second loss for contrastive supervision.

13. The electronic device of claim 12, wherein the second loss is determined based on:
a first distance between the positive noise and a true noise, and
a second distance between the negative noise and the true noise.

14. The electronic device of claim 10, wherein the right instruction is determined for a pair of the original sample data and the edited sample data by using a vision-language model.

15. The electronic device of claim 14, wherein the vision-language model is selected from a plurality of candidate vision-language models based on model capability for image understanding.

16. The electronic device of claim 10, wherein for a generation from the original sample data to the edited sample data, image layout and background are generated in an early stage, local object attributes are focused in a mid stage, and image details are focused in a later stage, with style changes throughout each of the early, mid, and later stages.

17. The electronic device of claim 10, wherein the wrong instruction is determined by a replacement of at least one phrase within the right instruction: quantities, spatial locations, or objects.

18. The electronic device of claim 10, wherein the electronic device is further caused to:
input the original image into a variational autoencoder to determine a latent representation of the original image; and
input the editing instruction and the latent representation into the trained editing model to obtain the model output.

19. A non-transitory computer readable medium comprising program instructions for causing an apparatus to:
obtain a model input comprising an original image and an editing instruction; and
determine a model output by inputting the model input into a trained editing model, wherein the model output comprises an edited image corresponding to the model input,
wherein the trained editing model is determined based on a training dataset comprising a plurality of positive and negative sample pairs, wherein a positive sample in a positive and negative sample pair comprises original sample data, a right instruction, and edited sample data, and wherein a negative sample in the positive and negative sample pair comprises the original sample data, a wrong instruction, and the edited sample data.

20. The non-transitory computer readable medium of claim 19, wherein the program instructions are causing the apparatus to:
input the original image into a variational autoencoder to determine a latent representation of the original image; and
input the editing instruction and the latent representation into the trained editing model to obtain the model output.
